(19) United States
(12) Patent Application Publication
(10) Pub. No.: US 2014/0298379 A1
(43) Pub. Date: Oct. 2, 2014

(54) 3D Mobile and Connected TV Ad Trafficking System

(71) Applicant: YuMe, Inc., Redwood City, CA (US)

(72) Inventor: Zubin Singh, Cupertino, CA (US)

(73) Assignee: YuMe, Inc., Redwood City, CA (US)

(21) Appl. No.: 14/214,933

(22) Filed: Mar. 15, 2014

Related U.S. Application Data
(60) Provisional application No. 61/798,271, filed on Mar. 15, 2013.

(51) Int. Cl. H04N 21/234; H04N 21/81

(52) U.S. Cl. CPC H04N 21/23424; H04N 21/812
USPC 725/32

(57) ABSTRACT

In an example embodiment, an ad trafficker includes: a microprocessor; a network interface coupled to the microprocessor; and memory including code segments executable on the microprocessor for a) uploading an advertisement (ad) via the network interface; b) determining whether the ad should be processed; and c) processing the ad if it is determined that the ad should be processed. In a further example embodiment, a method for gesture and voice command control of video advertisements includes: a) displaying an advertisement (ad) content on a video display apparatus; b) ending the display of the ad content if it is determined that the ad content has been completed; c) performing an action related to an audio command detected by a microphone if an audio command is detected by the microphone; d) performing an action related to a gesture if a gesture is detected by a stereo video camera; and repeating.

### CROSS REFERENCE TO RELATED APPLICATION(S)

This application claims the benefits of provisional patent application U.S. Ser. No. 61/798,271 filed Mar. 15, 2013, which is incorporated herein by reference.

### BACKGROUND

Ad trafficking or “ad serving” describes the technology and service that places advertisements for viewing on personal computers and other Internet-connected systems and devices such as smartphones, tablet computers, game units and “connected TV.” Ad serving technology companies provide software to serve ads, count them, choose the ads that will make the website or advertiser the most money, and monitor progress of different advertising campaigns.

Advertising can be very competitive and Internet advertising is no exception. It is therefore desirable to be able to serve ads to as many platforms as possible. Furthermore, it is desirable to leverage on the unique capabilities of each platform to enhance the advertising experience.

Connected TV (“CTV”), sometimes referred to as Smart TV or Hybrid TV, describes a trend of integration of the Internet and Web 2.0 features into television sets, as well as the technological convergence between computers and television sets. These devices have a higher focus on online interactive media, Internet TV and on-demand streaming media and less focus on traditional broadcast media than traditional television. The technology that enables connected TV is also incorporated in devices such as set-top boxes, Blu-ray players, game consoles and other devices. Some connected TV platforms include digital camera systems and audio inputs that can be used to control various functions of the TV.

Another emerging technology is that of 3D graphical displays. For example, many devices such as televisions, computer screens and even mobile phones are capable of display 3D video images. These images can be created, for example, by the Mobile 3D Graphics API, commonly referred to as M3G, is a specification defining an API for writing Java program that produce 3D computer graphics. It extends the capabilities of the Java ME, a version of the Java platform tailored for embedded devices such as mobile phones and PDSs. The object-oriented interface consists of 30 classes that can be used to draw complex animated three-dimensional scenes. M3G was designed to meet the specific needs of mobile devices, which are constricted in terms of memory, and processing power. The API's architecture allows it to be implemented completely inside software or take advantage of the hardware present on the device.

Motion control technologies are also beginning to be provided in CTVs and in set-top boxes. For example, Microsoft Kinect® provides that functionality, and manufacturers such as Samsung, LG and Hitachi have created motion controlled TVs. However, such technologies are typically used to control the CTVs, not content of the CTVs.

These and other limitations of the prior art will become apparent to those of skill in the art upon a reading of the following descriptions and a study of the several figures of the drawing.

### SUMMARY

In an embodiment, a system is provided which overlays gesture and voice commands with respect to a video advertisement.

In another embodiment, a method and system is provided for uploading video advertisements to an ad trafficking server and for optionally processing the video advertisements to convert it from 2D to 3D.

In another embodiment, a method is provided for associating gestures and voice commands with actions related to a video advertisement.

In a further embodiment, a method is provide for displaying content, detecting commands, and performing actions related to the detected commands.

In a still further embodiment a system is provide to control a video display showing a video advertisement using gestures and/or voice commands which initiate actions related to the commands.

Systems and methods described herein enhance the enjoyment and engagement of users with respect to advertisements delivered over the Internet. Systems and methods described herein also provide additional information to advertisers concerning the distribution and viewing of their advertisements.

These and other embodiments, features and advantages will become apparent to those of skill in the art upon a reading of the following descriptions and a study of the several figures of the drawing.

### BRIEF DESCRIPTION OF THE DRAWINGS

Several example embodiments will now be described with reference to the drawings, wherein like components are provided with like reference numerals. The example embodiments are intended to illustrate, but not to limit, the invention. The drawings include the following figures:

FIG. 1 is a diagram illustrating an example system implementing features described herein;

FIG. 2 is a block diagram of an example computerized system;

FIG. 3 is a flow diagram of an example process for uploading and processing a video advertisement;

FIG. 4 is a flow diagram of an example process for overlaying a video advertisement with gesture and/or voice command overlays;

FIG. 5 is a flow diagram of an example process for controlling a video advertisement provided with gesture and/or voice command overlays;

FIG. 6 illustrates an example gesture overlay;

FIG. 7 illustrates an example gesture and/or voice overlay; and

FIG. 8 illustrates an example system provided with control of a video display with gestures and/or voice commands.

### DETAILED DESCRIPTION OF EXAMPLE EMBODIMENTS

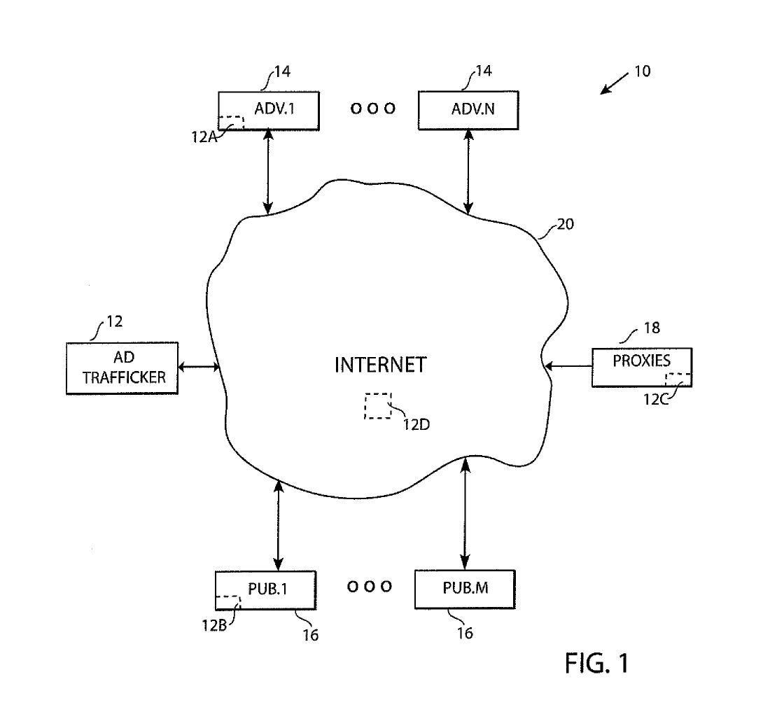

FIG. 1 illustrates a system 10 supporting a process for serving enhanced advertisements to publishers over the Internet in accordance with a non-limiting example. In this example, the system 10 includes one or more ad trafficking servers 12, one or more advertiser computers 14 and one or more publisher server systems 16. The system at 10 may further include other computers, servers or computerized systems such as proxies 18. In this example, the ad trafficking servers 12, advertiser computers 14, publisher server systems 16 and proxies 18 can communicate by a wide area network such as the Internet 20 (also known as a “global network” or a “wide area network” or “WAN” operating with TCP/IP packet protocols). The ad trafficking servers 12 can be implemented as a single server or as a number of servers, such as a server farm and/or virtual servers, as will be appreciated by those of skill in the art.

As used herein, the term “publisher” refers to an entity or entities which publish content with which advertisements (“ads”) can be associated. The term “advertiser” refers to an entity which advertises its products, services and/or brands. The term “ad trafficker”, “ad agency”, and/or “ad network” refers to entities serving the middleman role of matching advertisers with publishers.

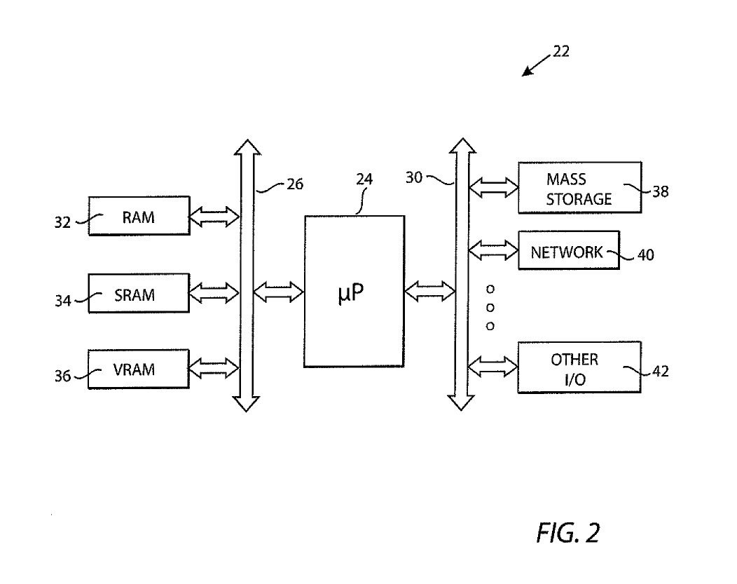

FIG. 2 is a simplified block diagram of a computer and/or server 22 suitable for use in system 10. Such computers and/or servers are available from a number of sources including Hewlett Packard Company of Palo Alto, Calif., Dell, Inc. of Austin Tex., Apple, Inc. of Cupertino, Calif., etc. By way of non-limiting example, computer 22 includes a microprocessor 24 coupled to a memory bus 26 and an input/output (I/O) bus 30. A number of memory and/or other high speed devices may be coupled to memory bus 26 such as the RAM 32, SRAM 34 and VRAM 36. Attached to the I/O bus 30 are various I/O devices such as mass storage 38, network interface 40, and other I/O 42. As will be appreciated by those of skill in the art, there are a number of computer readable media available to the microprocessor 24 such as the RAM 32, SRAM 34, VRAM 36 and mass storage 38. The network interface 40 and other I/O 42 also may include computer readable media such as registers, caches, buffers, etc. Mass storage 38 can be of various types including hard disk drives, optical drives and flash drives, to name a few.

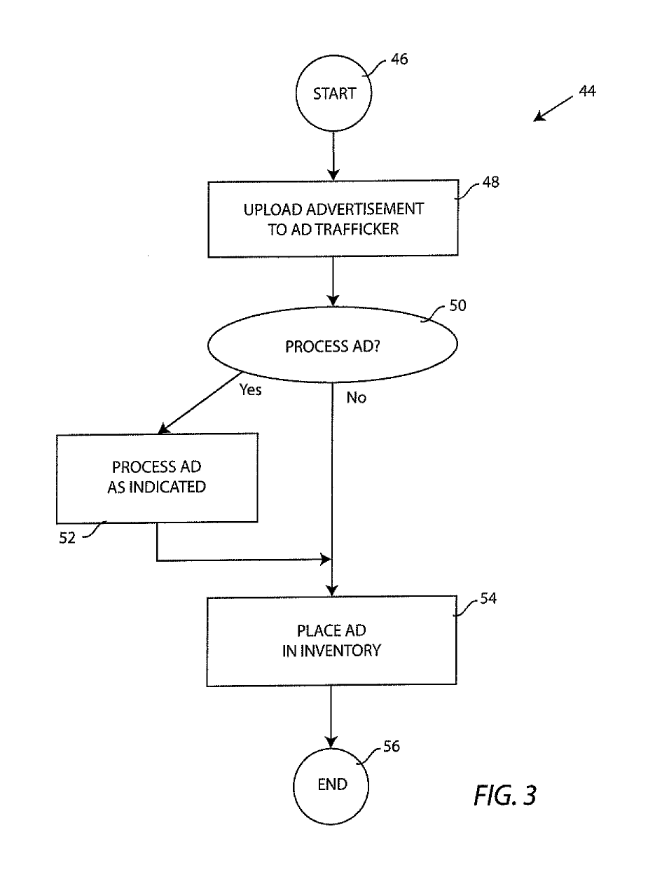

FIG. 3 illustrates a process 44, set forth by way of example and not limitation, for processing advertisements over the Internet. Process 44 begins at 46 and, in an operation 48, an advertisement (“ad”) is uploaded to an ad trafficker 12 from an advertiser 14. The upload operation 48 may be accomplished over Internet 20 by, for example, by using the Internet's File Transfer Protocol (FTP) process. Next, in an operation 50, it is determined if the ad is to be digitally processed. For example, the ad, which can be a video or an image file, could be converted from a flat or “2D” format into a three-dimensional or “3D” format in an operation 52, if desired. The ad is placed in inventory in an operation 54 and the process 44 ends at 56.

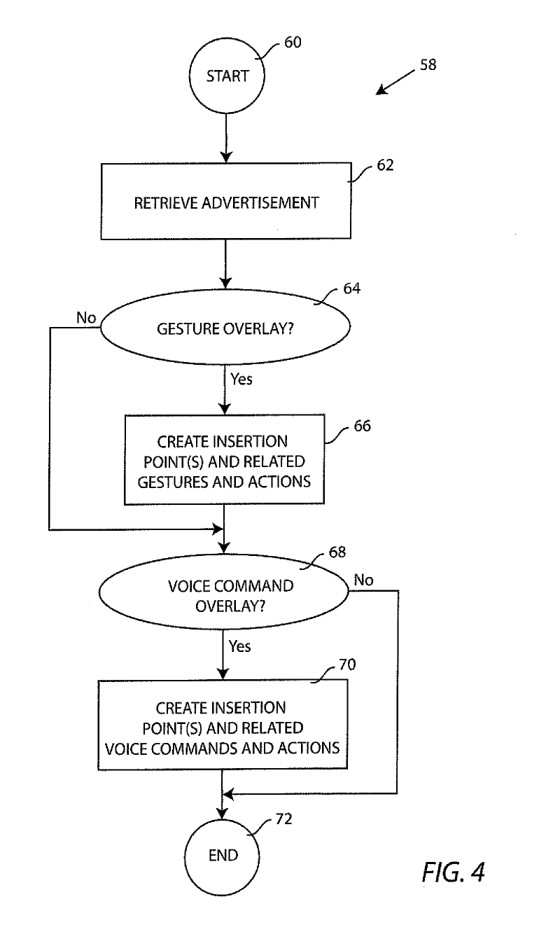

FIG. 4 illustrates a process 58, set forth by way of example and not limitation, for creating an “overlay” for an advertisement. The process 58 begins at 60 and, in an operation 52, and advertisement is retrieved. Next, in an operation 64, it is determined if the advertisement is to be enhanced with gesture overlay(s). If so, an operation 66 creates insertion points in the advertisement and gestures and actions are associated with those insertion points. For example, an insertion point can be upon the display of a car in a video advertisement, the gesture could be defined as a swipe or a hand-wave, and the action can be opening a website that provides additional information about the car.

Next, in an operation 68, it is determined if voice overlays are to be associated with the advertisement. If so, an operation 70 creates insertion point(s) and related voice commands and actions. For example, the insertion point can be a display of a car, the voice command can be the spoken words “more information” and the action could be opening a website that provides more information about the car. The process 58 is then completed at 72.

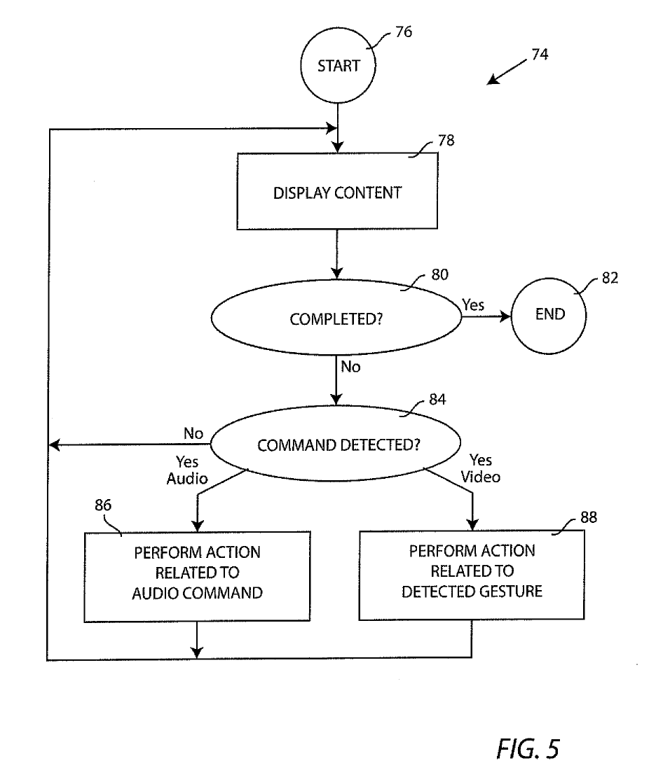

FIG. 5 illustrates a process 74, set forth by way of example and not limitation, for controlling a display system provided with video and audio sensors. Process 74 begins at 76 and, in an operation 78, content is displayed. For example, a video advertisement may be played on the display system. Next, in an operation 80, it is determined if the advertisement has been fully played. If so, the process 74 is completed at 82. If not, an operation 84 determines if the video or audio sensors have detected a command. If not, control is returned to operation 78. If an audio command has been detected by operation 84, an operation 86 performs the action related to the audio command. If a video command is detected by operation 84, an operation 88 performs the action related to the detected gesture. Control is then returned to operation 78.

It will be appreciated that the processes and systems described about employ a number of technologies including 3D conversion, gesture detection, and voice recognition. Such technologies are well known to those of skill in the art and software and/or hardware implementing such technologies are available from a number of sources. A brief description of some of the technologies is set forth below.

### 3D Conversion

2D-to-3D video conversion (also called 2D to stereo 3D conversion and stereo conversion) is the process of transforming 2D (“flat”) image content to a 3D format, which in almost all cases is stereo, requiring the creation of separate images for each eye from the 2D image.

2D-to-3D conversion adds the binocular disparity depth cue to digital images perceived by the brain and, if done properly, greatly improves the immersive effect while viewing stereo video in comparison to 2D video. However, in order to be successful, the conversion should be done with sufficient accuracy and correctness: the quality of the original 2D images should not deteriorate, and the introduced disparity cue should not contradict to other cues used by the brain for depth perception. If done properly and thoroughly, the conversion produces stereo video of similar quality to “native” stereo video which is shot in stereo and accurately adjusted and aligned in post-production.

In an embodiment, set forth by way of example and not limitation, the 2D content is automatically converted into 3D content. One method for automatic conversion is to impute depth from motion in the video using different types of motion. Another method it to determine depth from focus, also called “depth from defocus” and “depth from blur.” Yet another method is to impute depth from perspective which is based on the fact that parallel lines, such as railroad tracks and roadsides, appear to converge with distance, eventually reaching a vanishing point at the horizon.

### Gesture Recognition

Hand gesture recognition is to make a computerized apparatus know the meaning of a hand gesture, including the spatial information, the path information, the symbolic information, and the affective information. The hand gesture interaction is to further communicate with computer interactively. Vision based sensors, such as the video camera, the depth-aware camera, and the stereo camera are attractive because they do not require any contact with the hand making the gestures. For an example, the Microsoft Kinect® releases a player from the traditional game controller. Other movements, including body movements, can also convey gestures.

It is an advantage to use vision based methods on hand gestures with vision based sensors. Kinect® is a motion sensing input device by Microsoft for the Xbox 360 video game console and Windows PCs. Based around a webcam-style add-on peripheral for the Xbox 360 console, it enables users to control and interact with the Xbox 360 without the need to touch a game controller, through a natural user interface using gestures and spoken commands. Kinect builds on software technology developed internally by Rare, a subsidiary of Microsoft Game Studies, and on range camera technology developed by Israeli developer PrimeSense.

### Speech Recognition

In computer science, speech recognition (SR) is the translation of spoken words into text. It is also known as “automatic speech recognition”, “ASR”, “computer speech recognition”, “speech to text”, or just “STT”. Some SR systems use “training” where an individual speaker reads sections of text into the SR system. These systems analyze the person's specific voice and use it to fine tune the recognition of that person's speech, resulting in more accurate transcription. Systems that do not use training are called “Speaker Independent” systems. Systems that use training are called “Speaker Dependent” systems. The text can be used to control an apparatus by way of a look-up table which correlates the text to an associated action, by parsing the text for meaning and syntax, etc.

### Existing Equipment

A number of CTV manufacturers have integrated gesture recognition and speech recognition into their equipment. For example, Samsung TVs have voice and gesture control APIs open to developers and 3D display. LG also markets TVs with gesture control, voice control and 3D displays. Such controls are, however, general in nature and tend to relate to the operation of the CTV and not to user interaction with a display of content, such as video advertisements, on a television display.

### Example 1

### Gesture Overlay

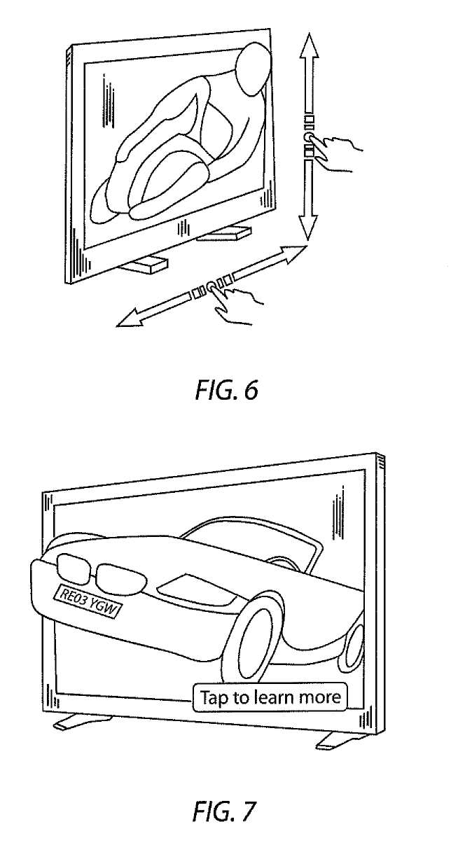

FIG. 6 illustrates a gesture overlay for a 3D video advertisement for a motorcycle. In this example, hand gestures are used in the horizontal and vertical direction to alter the display of the video.

### Example 2

### Gesture and Voice Command Overlays

FIG. 7 illustrates a gesture overlay for a 3D video advertisement for a car. The banner “Tap to learn more” overlies the advertisement. In this example, a hand gesture can be used to “tap” the banner or a user can give the voice command “tap.” Upon the detection of either of these gestures, additional information concerning the car will be displayed and/or spoken.

### Example 3

### System for Gesture and Voice Command Overlays

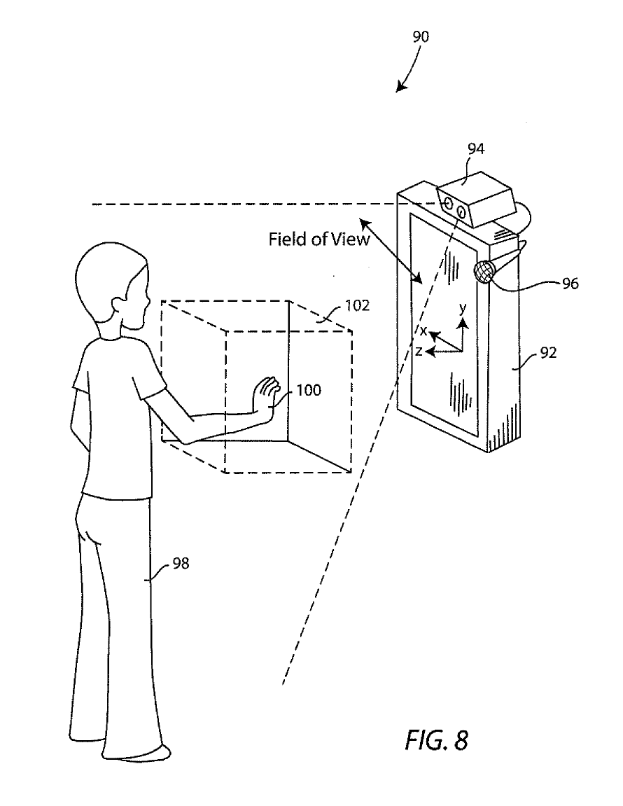

FIG. 8 illustrates a system 90, set forth by way of example and not limitation, for gesture and voice command control of video advertisements includes a video display apparatus 92, a stereo video camera 94 and a microphone 96. Digital processors and software of the video display apparatus performs the gesture recognition and speech recognition processes described above. A user 98 is, in this example, standing in front of the video display such that his hand 100 is within the field of view of the stereo video camera 94. When the user's hand 100 is within the volume of interest 102, the digital processors and software of the video display apparatus 92 convert movements of hand 100 into recognized gestures or commands. The user can also provide voice commands to the video display by way of the microphone 96.

In an embodiment, the stereo video camera 94 can detect if a person is in front of the video display 92 (or CTV, as another example). This feature can be embedded into the video advertisement at the time of overlaying the ad with gesture commands capability. Furthermore, trackers can be fired to track how many viewers were exposed to the video advertisement.

Although various embodiments have been described using specific terms and devices, such description is for illustrative purposes only. The words used are words of description rather than of limitation. It is to be understood that changes and variations may be made by those of ordinary skill in the art without departing from the spirit or the scope of various inventions supported by the written disclosure and the drawings. In addition, it should be understood that aspects of various other embodiments may be interchanged either in whole or in part. It is therefore intended that the claims be interpreted in accordance with the true spirit and scope of the invention without limitation or estoppel.

What is claimed is:

1. An ad trafficker comprising:
a microprocessor;
a network interface coupled to the microprocessor; and
memory including code segments executable on the microprocessor for:
a) uploading an advertisement (ad) via the network interface;
b) determining whether the ad should be processed; and
c) processing the ad if it is determined that the ad should be processed.

2. An ad trafficker as recited in claim 1 wherein processing the ad includes an automatic conversion of 2D content to 3D content.

3. An ad trafficker as recited in claim 2 wherein processing the ad includes creating one or more insertion points.

4. An ad trafficker as recited in claim 3 further comprising code segments creating one or more related gestures and actions if it is determined that there is to be a gesture overlay for the ad.

5. An ad trafficker as recited in claim 3 further comprising code segments creating one or more related voice commands and actions if it is determined that there is to be a voice command overlay for the ad.

6. An ad trafficker as recited in claim 4 further comprising code segments creating one or more related voice commands and actions if it is determined that there is to be a voice command overlay for the ad.

7. An ad trafficker as recited in claim 6 further comprising code segments placing the ad in inventory.

8. An ad trafficker as recited in claim 1 wherein processing the ad includes creating one or more insertion points.

9. An ad trafficker as recited in claim 8 further comprising code segments creating one or more related gestures and actions if it is determined that there is to be a gesture overlay for the ad.

10. An ad trafficker as recited in claim 8 further comprising code segments creating one or more related voice commands and actions if it is determined that there is to be a voice command overlay for the ad.

11. An ad trafficker as recited in claim 9 further comprising code segments creating one or more related voice commands and actions if it is determined that there is to be a voice command overlay for the ad.

12. An ad trafficker as recited in claim 11 further comprising code segments placing the ad in inventory.

13. A system for gesture and voice command control of video advertisements comprising:
a video display apparatus;
a stereo video camera; and
a microphone; and
at least one digital processor and software comprising code segments executable on the digital processor for:
(a) displaying an advertisement (ad) content on the video display apparatus;
(b) ending the display of the ad content if it is determined that the ad content has been completed;
(c) performing an action related to an audio command if an audio command is detected by the microphone;
(d) performing an action related to a gesture if a gesture is detected by the stereo video camera; and
(e) repeating operations (a)-(d).

14. A system for gesture and voice command control of video advertisements as recited in claim 13 wherein the at least one digital processor and software form a part of the video display apparatus.

15. A system for gesture and voice command control of video advertisements as recited in claim 14 wherein the gesture is made with a hand of a user standing in front of the video display device.

16. A system for gesture and voice command control of video advertisements as recited in claim 15 wherein the hand of the user is within a volume of interest defined by x, y and z coordinates.

17. A system for gesture and voice command control of video advertisements as recited in claim 16 wherein the volume of interest is within a field of view of the stereo video camera.

18. A method for gesture and voice command control of video advertisements comprising:
(a) displaying an advertisement (ad) content on a video display apparatus;
(b) ending the display of the ad content if it is determined that the ad content has been completed;
(c) performing an action related to an audio command detected by a microphone if an audio command is detected by the microphone;
(d) performing an action related to a gesture if a gesture is detected by a stereo video camera; and
(e) repeating operations (a)-(d).

19. A method for gesture and voice command control of video advertisements as recited in claim 18 wherein the gesture is made with a hand of a user that is within a volume of interest defined by x, y and z coordinates.

20. A system for gesture and voice command control of video advertisements as recited in claim 19 wherein the volume of interest is within a field of view of the stereo video camera.
